(19) United States
(12) Patent Application Publication
(10) Pub. No.: US 2025/0132642 A1
(43) Pub. Date: Apr. 24, 2025

(54) MOTOR, BLOWER, AND VEHICLE

(71) Applicant: Panasonic Intellectual Property Management Co., Ltd., Osaka (JP)

(72) Inventors: MASATSUGU KATO, Hyogo (JP); YASUAKI MATSUSHITA, Kyoto (JP); HIROKAZU YAMAUCHI, Fukui (JP)

(21) Appl. No.: 18/701,974

(22) PCT Filed: Sep. 20, 2022
(86) PCT No.: PCT/JP2022/034880

§ 371 Date: Oct. 17, 2024

(30) Foreign Application Priority Data
Nov. 5, 2021 (JP) 2021-181472

(51) Int. Cl. H02K 11/00; H02K 1/12; H02K 7/00; H02K 7/14

(52) U.S. Cl. CPC H02K 11/0094; H02K 1/12; H02K 7/003; H02K 7/14

(57) ABSTRACT

Provided are a motor, a blower, and a vehicle that can be further thinned. Outer rotor motor (1) includes stator (3), rotor (2), and electronic component (41). Stator (3) includes stator core (31). Rotor (2) includes rotary shaft (20), and has axis (A1) as a rotation center. Circuit board (4) includes electronic component (41). Stator core (31) includes stator body (32) and a plurality of teeth (33). Stator body (32) has shaft hole (36) into which rotary shaft (20) is inserted. The plurality of teeth (33) are provided at an end portion of stator body (32). Stator body (32) further includes cavity portion (37) different from shaft hole (36). Electronic component (41) is disposed in cavity portion (37).

### TECHNICAL FIELD

The present disclosure relates to a motor, a blower, and a vehicle, and more particularly, to an outer rotor motor, a blower including a motor, and a vehicle including a blower.

### BACKGROUND ART

PTL 1 describes an outer rotor motor. In the motor described in PTL 1, an electronic component is disposed in a space formed in a central portion of a stator core.

### CITATION LIST

### Patent Literature

PTL 1: Unexamined Japanese Patent Publication No. 2001-204156

### SUMMARY OF THE INVENTION

However, in the motor of PTL 1, the space formed in the central portion of the stator core is provided between a protective cover and a circuit board, and the protective cover temporarily fixes a shaft (rotary shaft). That is, the space in which the electronic component is disposed and the rotary shaft are partitioned by the protective cover. Accordingly, in the motor of PTL 1, the rotary shaft and the electronic component are in a positional relationship of overlapping each other in plan view from an extending direction of an axis, and it is difficult to further reduce a thickness of the motor in the extending direction of the axis.

The present disclosure has been made in view of the above points, and an object of the present disclosure is to provide a motor, a blower, and a vehicle that are further thinned.

A motor according to one aspect of the present disclosure is a motor that is an outer rotor motor. The motor includes a stator, a rotor, and an electronic component. The stator includes a stator core. The rotor includes a rotary shaft, and has an axis of the rotary shaft as a rotation center. The stator core includes a stator body and a plurality of teeth. The stator body includes a shaft hole into which the rotary shaft is inserted. The plurality of teeth are provided at an end portion of the stator body. The stator body further includes a cavity portion different from the shaft hole. The electronic component is disposed within the cavity portion.

A blower according to another aspect of the present disclosure includes the motor and a blade fixed to the rotary shaft of the motor.

A vehicle according to still another aspect of the present disclosure includes the blower and a vehicle body that stores the blower.

According to the motor, the blower, and the vehicle according to the above aspects of the present disclosure, it is possible to further thin the motor.

### BRIEF DESCRIPTION OF THE DRAWINGS

FIG. 1 is an external view of a motor according to a first exemplary embodiment.

FIG. 2 is a sectional view of the motor according to the first exemplary embodiment.

FIG. 3 is another sectional view of the motor according to the first exemplary embodiment.

FIG. 4 is an external view of a stator core of the motor according to the first exemplary embodiment.

FIG. 5A is a schematic view illustrating an example of a sectional shape of a cavity portion of the stator core of the motor according to the first exemplary embodiment.

FIG. 5B is a schematic view illustrating another example of the sectional shape of the cavity portion of the stator core of the motor according to the first exemplary embodiment.

FIG. 5C is a schematic view illustrating still another example of the sectional shape of the cavity portion of the stator core of the motor according to the first exemplary embodiment.

FIG. 6 is a schematic view illustrating a positional relationship between a cavity portion of a stator core of a motor and a teeth according to a first modification.

FIG. 7 is a schematic view of a blower according to a second exemplary embodiment.

FIG. 8 is a schematic view of a vehicle according to a third exemplary embodiment.

### DESCRIPTION OF EMBODIMENT

Hereinafter, a motor, a blower, and a vehicle according to exemplary embodiments of the present disclosure will be described in detail with reference to the drawings. However, the drawings described in the following exemplary embodiments are merely schematic views, and ratios in size and thickness of components do not always reflect actual dimensional ratios. Note that, the configurations described in the following exemplary embodiments are merely examples of the present disclosure. The present disclosure is not limited to the following exemplary embodiments, and various modifications can be made depending on design and the like as long as effects of the present disclosure can be achieved.

### First Exemplary Embodiment

### (1) Overall Configuration of Motor

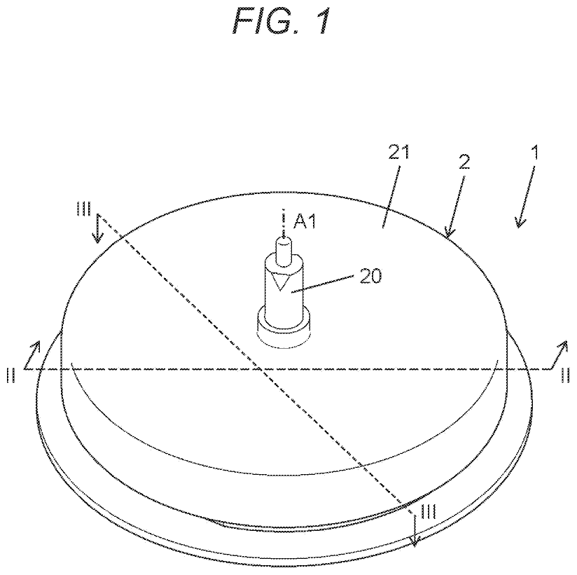

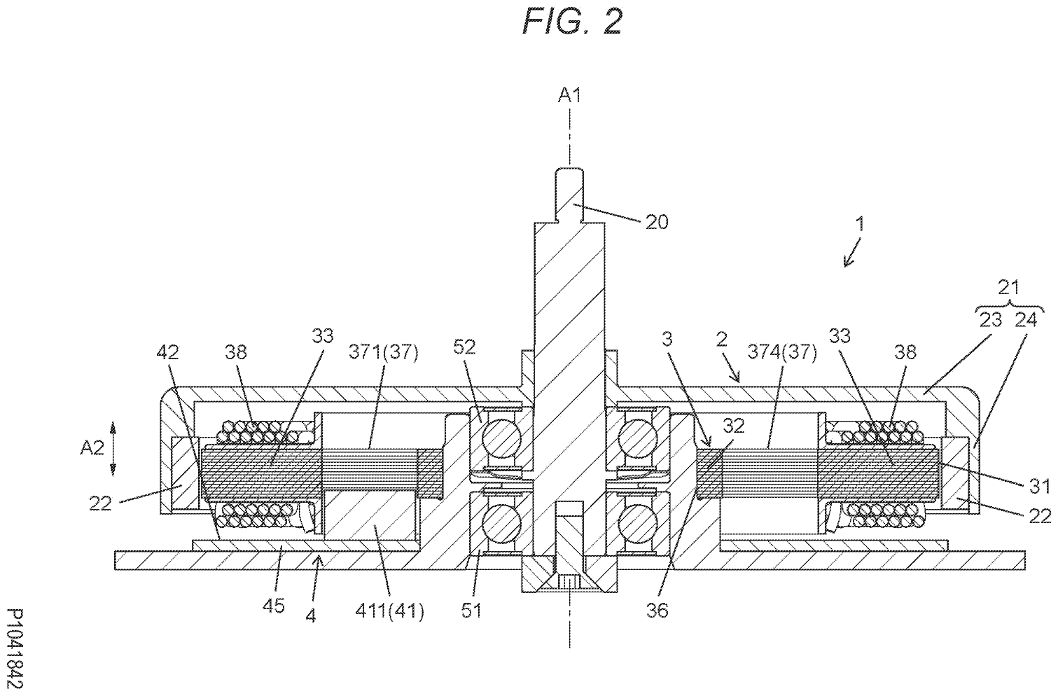

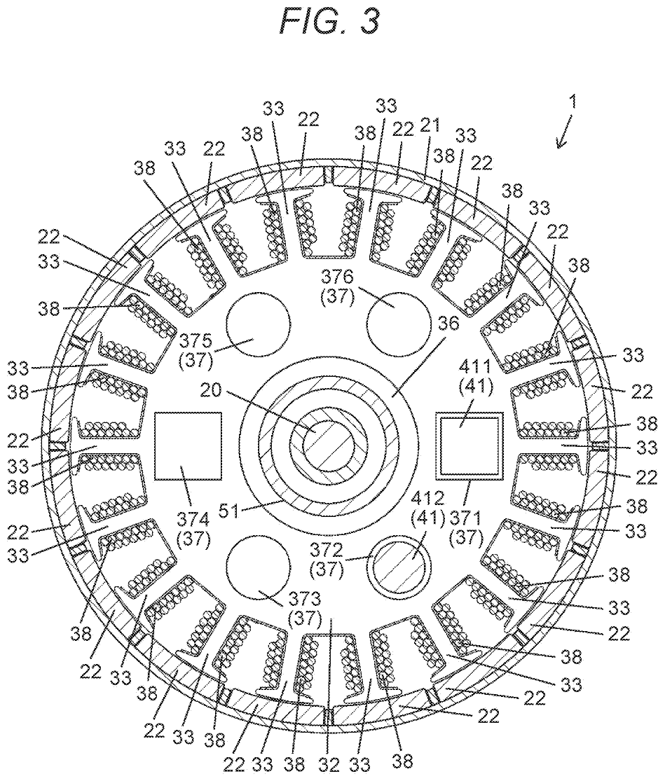

Motor 1 according to a first exemplary embodiment of the present disclosure is an outer rotor motor. As illustrated in FIGS. 1 to 3, motor 1 includes rotor 2, stator 3, circuit board 4, and bearings 51 and 52. Note that, FIG. 1 is an external view of motor 1. In addition, FIG. 2 is a sectional view of the motor taken along a plane including axis A1 of rotary shaft 20 of rotor 2 and line II-II orthogonal to axis A1. In addition, FIG. 3 is a sectional view of the motor taken along a plane including line III-III orthogonal to axis A1 and passing through the center of rotor core 21 with axis A1 of rotary shaft 20 of rotor 2 as a normal line.

As illustrated in FIGS. 1 to 3, rotor 2 includes rotary shaft 20, rotor core 21, and a plurality of (16 in FIG. 3) permanent magnets 22. The plurality of permanent magnets 22 are held by rotor core 21. Stator 3 includes stator core 31 and a plurality of (18 in FIG. 3) coils 38. Permanent magnet 22 is disposed around stator core 31. That is, rotor cores 21 surround stator core 31. The plurality of coils 38 are wound around stator core 31. Rotor 2 rotates with respect to stator 3. That is, magnetic flux (magnetic force) generated from the plurality of coils 38 acts on the plurality of permanent magnets 22, and thus, rotor 2 rotates. A rotational force (driving force) of rotor 2 is output from rotary shaft 20 to an outside of motor 1.

### (2) Components of Motor

### (2-1) Rotor

Rotor 2 includes rotor core 21, the plurality of permanent magnets 22, and rotary shaft 20.

Rotor core 21 includes circular plate part 23 and cylinder 24. Circular plate part 23 has a circular plate shape with axis A1 as a center, and a thickness direction of circular plate part 23 is a direction parallel to axis A1. Cylinder 24 has a hollow cylindrical shape with axis A1 as an axis. An outer peripheral portion of circular plate part 23 is connected to one end of cylinder 24 in a direction (hereinafter, referred to as extending direction A2 of axis A1 or simply as extending direction A2) parallel to axis A1. In plan view from extending direction A2 of axis A1, cylinder 24 surrounds stator 3. On an inner peripheral surface of cylinder 24, the plurality of permanent magnets 22 are arranged at equal intervals along an inner peripheral surface of cylinder 24. The plurality of permanent magnets 22 faces stator 3. Rotary shaft 20 extends along extending direction A2 of axis A1. Rotary shaft 20 penetrates a center of circular plate part 23. Stator 3 is positioned between rotary shaft 20 of rotor 2 and cylinder 24 of rotor core 21.

### (2-2) Stator

Stator 3 includes stator core 31 and the plurality of coils 38.

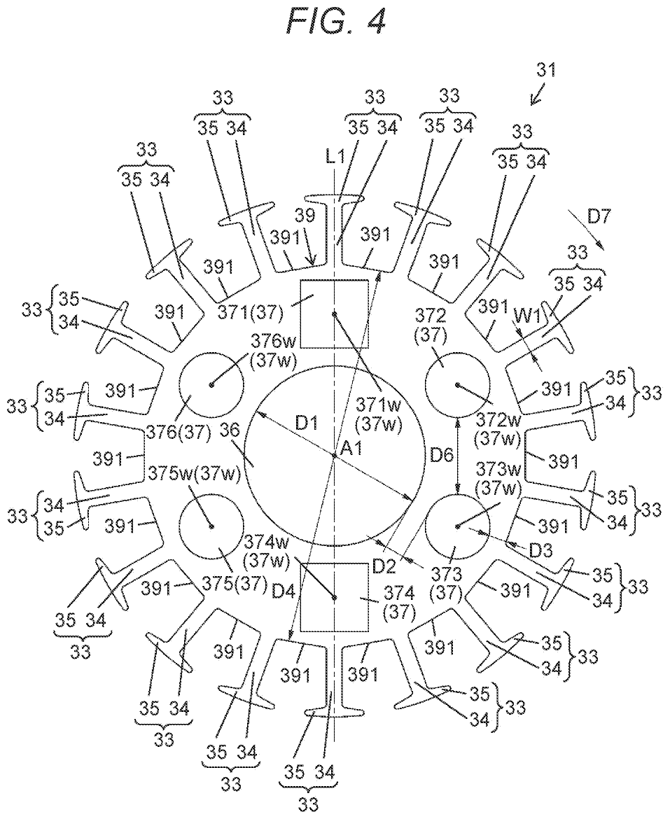

FIG. 4 is an external view of stator core 31 according to motor 1 of the present exemplary embodiment. Stator core 31 includes stator body 32 and a plurality of (18 in FIGS. 3 and 4) teeth 33. Stator body 32 has a hollow circular plate shape with axis A1 as a center. The plurality of teeth 33 protrude from end portion 39 (see FIG. 4) of stator body 32 outside in a radial direction. In end portion 39, a portion between two adjacent teeth 33 is outer peripheral edge 391 of stator body 32. In other words, teeth 33 are provided between two outer peripheral edges 391 adjacent to each other.

In addition, shaft hole 36 is provided in stator body 32. Shaft hole 36 is a through-hole having a cylindrical shape and having diameter D1 (see FIG. 4) with axis A1 as a central axis. In shaft hole 36, bearings 51 and 52 and rotary shaft 20 are disposed. In addition, in stator body 32, one or more (six in FIGS. 3 and 4) cavity portions 37 are formed. As illustrated in FIGS. 3 and 4, six cavity portions 37 include cavity portions 371, 372, 373, 374, 375, and 376.

Each of cavity portions 37 is formed between end portion 39 of stator body 32 and shaft hole 36. That is, each of cavity portions 37 is formed between outer peripheral edge 391, tooth 33, and shaft hole 36. Each of cavity portions 37 penetrates stator body 32 in, for example, extending direction A2 of axis A1. Each of cavity portions 37 has, for example, a columnar shape or a prism shape. As will be described later, at least one cavity portion 37 in which electronic component 41 is disposed is present. In FIGS. 2 and 3, electronic component 411 is disposed within cavity portion 371. In addition, electronic component 412 is disposed within cavity portion 372.

As illustrated in FIG. 4, each of the plurality of teeth 33 includes body portion 34 and distal end portion 35. Body portion 34 protrudes outward in the radial direction of stator body 32 from end portion 39 of stator body 32. Body portions 34 of the plurality of teeth 33 are provided at equal intervals in a circumferential direction of stator body 32 (a rotation direction of rotor 2). Distal end portion 35 protrudes from a distal end of body portion 34. The plurality of teeth 33 correspond to the plurality of coils 38 on a one-to-one basis. Each of coils 38 is formed by winding a conductive wire around body portion 34 of corresponding tooth 33.

### (2-3) Circuit Board

As illustrated in FIG. 2, circuit board 4 includes substrate base material 45 and circuit element disposed on substrate base material 45. Substrate base material 45 of circuit board 4 is, for example, a printed board. Substrate base material 45 of circuit board 4 is formed in a substantially circle in plan view from extending direction A2 of axis A1, and has a through-hole through which rotary shaft 20 passes in a central portion.

A plurality of circuit elements for drive motor 1 are provided in principal surface 42 of substrate base material 45. The plurality of circuit elements constitute a drive circuit that drives motor 1. The drive circuit includes one or more (two in FIG. 3) electronic components 41. As illustrated in FIG. 3, two electronic components 41 include electronic component 411 and electronic component 412. Each of electronic components 41 is, for example, a relatively tall component, a so-called tall component, and is, for example, an inductor, a transformer, a capacitor, or the like.

Each of electronic components 41 is disposed such that an entire region of electronic component 41 overlaps any one cavity portion 37 of stator core 31 in plan view from extending direction A2 of axis A1. As illustrated in FIG. 3, in plan view from extending direction A2 of axis A1, the entire region of electronic component 411 overlaps cavity portion 371. In addition, in plan view from extending direction A2 of axis A1, the entire region of electronic component 412 overlaps cavity portion 372. Accordingly, in motor 1 according to the first exemplary embodiment, in a case where a distance between principal surface 42 of substrate base material 45 and stator core 31 is smaller than a height of electronic component 41 (a distance between principal surface 42 of substrate base material 45 and an upper end of electronic component 41), a part of electronic component 41 is disposed within cavity portion 37. That is, in motor 1, even though electronic component 41 is the tall component, since circuit board 4 and stator core 31 can be brought close to each other along extending direction A2 of axis A1, motor 1 can be thinned.

Note that, in a case where there are the plurality of electronic components 41, each of electronic components 41 may be positioned within any one cavity portion 37 of cavity portions 37 of stator core 31. In other words, electronic component 41 is not necessarily disposed inside all cavity portions 37. As illustrated in FIG. 3, electronic component 41 is not disposed inside each of cavity portions 373 to 376. In addition, for example, in a case where circuit board 4 includes one electronic component 41, electronic component 41 is positioned within any one cavity portion 37 of cavity portions 37 provided in stator core 31. Alternatively, for example, in a case where circuit board 4 includes two electronic components 41, each of two electronic components 41 is positioned within different cavity portion 37 of cavity portions 37 provided in stator core 31. Note that, the drive circuit may include a component having a height lower than the distance between principal surface 42 of circuit board 4 and stator core 31, and the component does not need to be present inside cavity portion 37.

### (2-4) Bearing

As illustrated in FIGS. 2 and 3, bearing 51 is disposed within shaft hole 36 of stator core 31. In addition, as illustrated in FIGS. 2 and 3, bearing 52 is disposed within shaft hole 36 of stator core 31. Two bearings 51 and 52 are arranged in extending direction A2 of axis A1. In addition, a rotary shaft of each of two bearings 51 and 52 coincides with axis A1. Then, both bearing 51 and bearing 52 hold rotary shaft 20.

Accordingly, rotary shaft 20 is held by at least two bearings 51 and 52. Accordingly, stability of axis A1 of rotary shaft 20 is improved, and a shaft deviation of rotor 2 can be reduced. In addition, since wear of bearings 51 and 52 and rotary shaft 20 is suppressed by reducing the shaft deviation of rotor 2, a lifespan of motor 1 can be extended.

### (3) Details of Stator Core

### (3-1) Shape of Cavity Portion

FIG. 3 is a plan view of stator core 31 as viewed in plan view from extending direction A2 of axis A1. Hereinafter, the shape and disposition of cavity portion 37 will be described in detail.

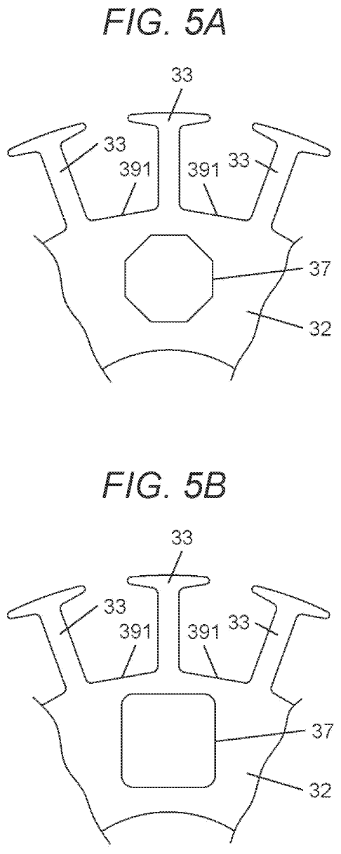

In the first exemplary embodiment, each of cavity portions 37 is a through-hole extending in extending direction A2 of axis A1. Each of cavity portions 37 has, for example, a columnar shape or a pillar shape such as a prism shape extending in extending direction A2 of axis A1. The shape (hereinafter, referred to as a “sectional shape”) of cavity portion 37 in plan view from extending direction A2 of axis A1 is, for example, a circle. Alternatively, the sectional shape of cavity portion 37 is, for example, a polygon. Examples of the polygon include a quadrangle, a hexagon, and an octagon, but other shapes may be used. In addition, the sectional shape of cavity portion 37 is preferably a regular polygon. That is, the sectional shape of cavity portion 37 may be a regular octagon as illustrated in FIG. 5A. Note that, in a case where the sectional shape of cavity portion 37 is a polygon, an angle formed by a side of the polygon with respect to an imaginary straight line connecting tooth 33 closest to cavity portion 37 and axis A1 may be any angle. For example, in a case where the sectional shape of cavity portion 37 is a square, an imaginary straight line connecting tooth 33 closest to cavity portion 37 and axis A1 and a pair of sides of the square may intersect at an angle of 90°. Alternatively, for example, in a case where the sectional shape of cavity portion 37 is the square, the imaginary straight line connecting tooth 33 closest to cavity portion 37 and axis A1 and the pair of sides of the square may intersect at an angle of 45°. Alternatively, for example, in a case where the sectional shape of cavity portion 37 is the square, the imaginary straight line connecting tooth 33 closest to cavity portion 37 and axis A1 and the pair of sides of the square may intersect at an angle of 30°. Note that, FIG. 5A is a schematic view illustrating an example of the sectional shape of cavity portion 37 of stator core 31.

In addition, the sectional shape of cavity portion 37 may be a shape in which corners of the polygon are replaced with arcs (a shape in which a vertex portion of the polygon is a curved surface). That is, the sectional shape of cavity portion 37 may be a shape in which each vertex of the square is replaced with an arc as illustrated in FIG. 5B. Note that, FIG. 5B is a schematic view illustrating another example of the sectional shape of cavity portion 37 of stator core 31.

Note that, the sectional shapes of all cavity portions 37 are not necessarily the same, and as illustrated in FIG. 4, cavity portions 37 having different sectional shapes may be mixed in stator core 31.

As an example, as a size of motor 1, an outer diameter is about 90 mm, and a height is about 20 mm to 25 mm, except for rotary shaft 20. In this case, when the sectional shape of cavity portion 37 is a circle, a diameter of each of cavity portions 37 is preferably, for example, from 8 mm to 12 mm inclusive. Within this preferable range, the electronic component has a size that allows the electronic component to enter cavity portion 37 and a size sufficient to secure a magnetic flux path. Note that, the size of motor 1 is an example, and there may be motors 1 of other sizes. In this case, the preferred value of the diameter of each of cavity portions 37 may vary.

In addition, in a case where the sectional shape of cavity portion 37 is a polygon, a vertex or a midpoint of a side of the polygon is preferably present on an imaginary straight line to be line-symmetric with respect to the imaginary straight line connecting tooth 33 closest to cavity portion 37 and axis A1. For example, in a case where the sectional shape of cavity portion 37 is the square, as illustrated in FIG. 4, a perpendicular bisector of each of the pair of sides of the square coincides with imaginary straight line L1. Alternatively, in a case where the sectional shape of cavity portion 37 is the square, for example, as illustrated in FIG. 5C, one diagonal line of the square overlaps with imaginary straight line L2. The sectional shape of cavity portion 37 is line-symmetric with respect to the imaginary straight line connecting tooth 33 closest to cavity portion 37 and axis A1, and thus, it is possible to reduce variations in magnetic flux density in a direction orthogonal to axis A1 and the imaginary straight line in a portion of stator body 32 around cavity portion 37. Accordingly, it is possible to reduce a decrease in rotational stability of rotor 2 due to cavity portion 37 provided in stator body 32. Note that, FIG. 5C is a schematic view illustrating still another example of the sectional shape of cavity portion 37 of stator core 31.

### (3-2) Position of Cavity Portion in Radial Direction

Each of cavity portions 37 is separated from shaft hole 36 of stator body 32. Cavity portion 37 and shaft hole 36 preferably has distance D2 of at least 5% or more of diameter D1 of shaft hole 36. Accordingly, since distance D2 between cavity portion 37 and shaft hole 36 can be made sufficiently long, strength of a portion between cavity portion 37 and shaft hole 36 in stator body 32 can be further increased.

In addition, each of cavity portions 37 is separated from outer peripheral edge 391 of stator body 32. Cavity portion 37 and outer peripheral edge 391 preferably has distance D3 of at least 50% or more of width W1 of tooth 33. Note that, width W1 of tooth 33 refers to a width of body portion 34 of tooth 33 in a direction orthogonal to imaginary straight line L1 connecting tooth 33 and axis A1. Accordingly, a portion of stator body 32 sandwiched between cavity portion 37 and outer peripheral edge 391 sufficiently functions as a yoke for magnetically coupling two teeth 33 adjacent to outer peripheral edge 391. That is, it is possible to reduce variations in magnetic flux density between two teeth 33 sandwiching outer peripheral edge 391 closest to cavity portion 37. In addition, a portion of stator body 32 sandwiched between cavity portion 37 and outer peripheral edge 391 has a sufficient width in a radial direction of tooth 33. Accordingly, it is possible to sufficiently increase the strength around cavity portion 37 of stator body 32.

Note that, in a case where the plurality of cavity portions 37 are provided in stator core 31, and in a case where the shapes and sizes of cavity portions 37 are the same, a distance between axis A1 and center positions of cavity portions 37 are preferably the same.

### (3-3) Position of Cavity Portion in Circumferential Direction of Stator Core

Each of cavity portions 37 is positioned between axis A1 and tooth 33 closest to cavity portion 37. More specifically, each of cavity portions 37 is present on imaginary straight line L1 corresponding to cavity portion 37. Imaginary straight line L1 is a straight line that is orthogonal to extending direction A2 of axis A1 and connects tooth 33 closest to corresponding cavity portion 37 and axis A1. Center of gravity 37w of cavity portion 37 refers to a position of a center of gravity of an object having the same shape as cavity portion 37 and uniform density in a case where the object is assumed to be inserted into cavity portion 37. For example, in a case where cavity portion 37 has a columnar shape extending in extending direction A2 of axis A1, a position of center of gravity 37w is a midpoint of a central axis of a column in extending direction A2. In addition, for example, in a case where cavity portion 37 is a quadrangular prism shape extending in extending direction A2 of axis A1 and having a square sectional shape, the position of center of gravity 37w is an intersection of diagonal lines of a quadrangular prism and is a punctuation point of diagonal lines of a square in plan view from extending direction A2. In addition, in each of cavity portions 37, center of gravity 37w of cavity portion 37 is preferably present on imaginary straight line L1 corresponding to cavity portion 37.

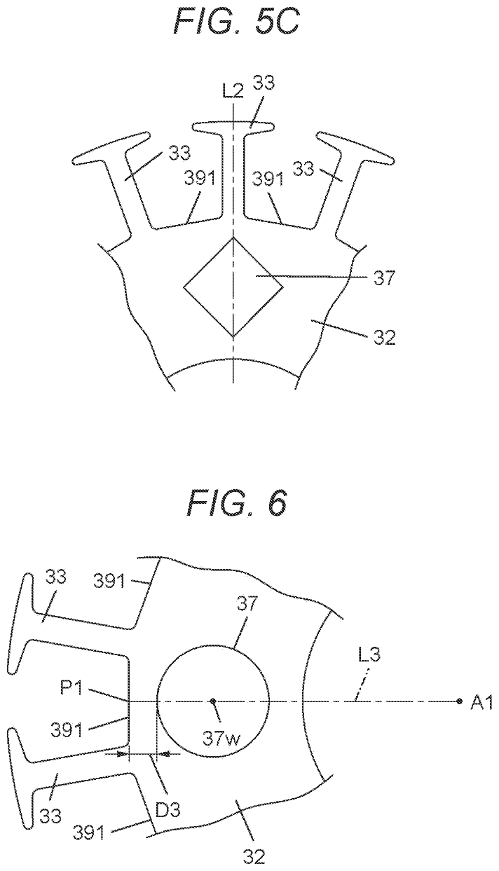

In a case where center of gravity 37w of cavity portion 37 is present on imaginary straight line L1, since tooth 33 is present on imaginary straight line L1 as illustrated in FIG. 4, distance D3 between cavity portion 37 and outer peripheral edge 391 of stator body 32 becomes long for cavity portions 37 having the same shape as compared with a case where center of gravity 37w of cavity portion 37 is present on imaginary straight line L3 (see FIG. 6). Accordingly, in a case where a center of cavity portion 37 is present on imaginary straight line L1, a magnetic flux from tooth 33 can easily pass through a region between cavity portion 37 and outer peripheral edge 391. In addition, outer peripheral edge 391 of stator body 32 is separated from cavity portion 37, and thus, the strength of the portion between outer peripheral edge 391 of stator body 32 and cavity portion 37 can be further increased.

### (3-4) Symmetry in Disposition of Cavity Portions

In a case where stator core 31 has the plurality of cavity portions 37, the plurality of cavity portions 37 are provided at equal intervals in circumferential direction D7 of stator body 32. More specifically, centers of gravity 37w of the plurality of cavity portions 37 are arranged at equal intervals in circumferential direction D7 of stator body 32. Accordingly, an angle formed by an imaginary straight line connecting center of gravity 37w of cavity portion 37 and axis A1 and an imaginary straight line connecting center of gravity 37w of cavity portion 37 adjacent to cavity portion 37 and axis A1 is constant. In other words, in two adjacent cavity portions (first cavity portion and second cavity portion) 37, an angle formed by a first imaginary straight line connecting center of gravity 37w of a first cavity portion and axis A1 and a second imaginary straight line connecting center of gravity 37w of a second cavity portion and axis A1 is constant. For example, in a case where stator core 31 has six cavity portions 37, cavity portions 37 are provided for every 60° in circumferential direction D7 of stator body 32. Accordingly, positions of centers of gravity 37w of the plurality of cavity portions 37 are symmetrical with respect to rotation of 60° along axis A1. In addition, in a case where the shapes of the plurality of cavity portions 37 are the same in a relationship between the imaginary straight lines connecting centers of gravity 37w of cavity portions 37 and axis A1, stator core 31 is symmetrical with respect to the rotation of 60°. With this configuration, it is possible to reduce variations in the influence of cavity portion 37 on the magnetic flux in circumferential direction D7 of stator body 32.

Alternatively, in a case where stator core 31 has the plurality of cavity portions 37, each of cavity portions 37 is line-symmetric with respect to an imaginary straight line orthogonal to axis A1. Accordingly, the positions of centers of gravity 37w of the plurality of cavity portions 37 are line-symmetric with respect to the imaginary straight line orthogonal to axis A1. In addition, for example, the shape of cavity portion 37 may be line-symmetric with respect to the imaginary straight line orthogonal to axis A1. For example, as illustrated in FIG. 4, in plan view from extending direction A2 of axis A1, stator core 31 is line-symmetric with respect to imaginary straight line L1 orthogonal to axis A1.

Note that, in a case where stator core 31 has the plurality of cavity portions 37 having different shapes, it is preferable that the positions of centers of gravity 37w of all cavity portions 37 are rotationally symmetric and cavity portions 37 having the same shape satisfy at least one of rotational symmetry and line symmetry. For example, in the case of stator core 31 illustrated in FIG. 4, the positions of centers of gravity 37w (371w to 376w) of all cavity portions 37 are rotationally symmetric by 60° and line-symmetric, cavity portion 37 having a quadrangular shape is rotationally symmetric by 180° and line-symmetric, and cavity portion 37 having a round shape is line-symmetric.

### (3-5) Number of Cavity Portions

In a case where the number of cavity portions 37 is 2 or more, the number of cavity portions is preferably a divisor of the number of teeth 33. According to this configuration, in a case where the plurality of cavity portions 37 are provided at equal intervals in circumferential direction D7 of stator body 32, a relative positional relationship between cavity portion 37 and tooth 33 close to cavity portion 37 is uniform for all cavity portions 37. That is, for example, in a case where one of cavity portions 37 is present on an imaginary straight line passing through tooth 33 closest to cavity portion 37 and axis A1, each of other cavity portions 37 is similarly present on an imaginary straight line corresponding to cavity portion 37. Accordingly, when the number of cavity portions 37 is n (n is an integer of 2 or more), the position of center of gravity 37w of cavity portion 37 has a symmetrical shape with respect to rotation of (360/n)°. Thus, variations in magnetic flux density in circumferential direction D7 of stator body 32 are reduced, and the rotational stability of rotor 2 is improved.

Note that, the number of cavity portions 37 is preferably a divisor of the number of magnetic poles of rotor 2. More preferably, the number of cavity portions 37 is a common divisor of the number of teeth 33 and the number of magnetic poles of rotor 2. According to this configuration, in a case where the plurality of cavity portions 37 are provided at equal intervals in circumferential direction D7 of stator body 32, a relative positional relationship between tooth 33 closest to cavity portion 37 and permanent magnet 22 positioned near tooth 33 is uniform for all cavity portions 37. For example, in a case where the number of teeth 33 is 12 and the number of magnetic poles of rotor 2 is 8, both tooth 33 and rotor 2 are symmetrical with respect to rotation of 90°. Accordingly, four cavity portions 37 are provided in stator core 31 such that the position of the center of gravity 37w of cavity portion 37 is symmetrical with respect to the rotation of 90°, and thus, it is possible to reduce the influence of cavity portion 37 on the magnetic flux in circumferential direction D7 of stator body 32.

### (3-6) Disposition of Electronic Component

Electronic component 41 is disposed inside any one of cavity portions 37.

As described above, a preferable number of cavity portions 37 is determined by the number of teeth 33 and the number of magnetic poles of rotor 2. On the other hand, a difference between the influence of cavity portion 37 in which electronic component 41 is disposed on stator body 32 around cavity portion 37 and the influence of cavity portion 37 in which electronic component 41 is not disposed on stator body 32 around cavity portion 37 is not as large as a difference between the influence of the presence or absence of cavity portion 37 on stator body 32. Accordingly, there may be cavity portion 37 in which electronic component 41 is not disposed. That is, the number of cavity portions 37 may be larger than the number of electronic components 41.

Note that, in a case where the number of cavity portions 37 is larger than the number of electronic components 41, cavity portions 37 in which electronic components 41 are disposed are preferably close to each other. For example, as illustrated in FIG. 4, in a case where stator core 31 has six cavity portions 37 and the number of electronic components 41 is 2, electronic components 41 are preferably disposed as follows. That is, electronic components 41 are preferably disposed in cavity portion 372 and cavity portion 373 such that electronic components 41 are disposed in cavity portion 372 and cavity portion 375. Specifically, a distance between cavity portion 37 in which electronic component 41 is disposed and another cavity portion 37 in which electronic component 41 is disposed is preferably less than or equal to 50% of a diameter of end portion 39 of stator body 32 (an outer diameter of stator body 32). With such a configuration, a wiring between two electronic components 41 on circuit board 4 can be shortened.

### (4) Effects

In motor 1 according to the first exemplary embodiment, electronic component 41 is disposed inside cavity portion 37 of stator core 31. Accordingly, even though electronic component 41 is a tall component such as an inductor, a transformer, or a capacitor, stator core 31 and circuit board 4 can be brought close to each other along extending direction A2 of axis A1. Accordingly, motor 1 can be thinned in extending direction A2.

In addition, in motor 1 according to the first exemplary embodiment, shaft hole 36 is provided in stator core 31 separately from cavity portion 37. Accordingly, even though electronic component 41 is the tall component, the plurality of bearings 51 and 52 supporting rotary shaft 20 can be disposed in shaft hole 36. Accordingly, the plurality of bearings 51 and 52 can be easily provided on rotary shaft 20 of motor 1, the shaft deviation can be reduced, and lifespans of rotary shaft 20 and bearings 51 and 52 can be extended.

In addition, in motor 1 according to the first exemplary embodiment, cavity portion 37 is disposed at a distance of 5% or more of diameter D1 of shaft hole 36 from shaft hole 36 of stator core 31. Accordingly, the strength of stator core 31 between shaft hole 36 and cavity portion 37 can be further increased.

In addition, in motor 1 according to the first exemplary embodiment, cavity portion 37 is disposed at a distance of 50% or more of width W1 of tooth 33 from outer peripheral edge 391 of stator body 32. Accordingly, since the distance between cavity portion 37 and outer peripheral edge 391 is sufficient, the magnetic coupling between stator body 32 and tooth 33 and the strength of stator core 31 can be further increased. Accordingly, with this configuration, the rotational stability of rotor 2 can be improved.

In addition, in motor 1 according to the first exemplary embodiment, cavity portion 37 is positioned on the imaginary straight line connecting tooth 33 and axis A1. Accordingly, in a case where the sizes of cavity portions 37 are the same, the distance between cavity portion 37 and outer peripheral edge 391 of stator body 32 can be increased. Accordingly, it is possible to increase the distance between cavity portion 37 and outer peripheral edge 391 of stator body 32 after increasing the sectional area of cavity portion 37.

In addition, in motor 1 according to the first exemplary embodiment, stator core 31 includes the plurality of cavity portions 37, and the positions of centers of gravity 37w of the plurality of cavity portions 37 satisfy at least one of line symmetry with respect to a straight line orthogonal to axis A1 and symmetry with respect to rotation of (360/n)° (n is the number of cavity portions 37) about axis A1. Accordingly, unevenness in magnetic flux density in the circumferential direction of stator core 31 can be reduced. That is, an increase in a cogging torque and an increase in a torque ripple of rotor 2 can be reduced to improve the rotational stability.

In addition, in motor 1 according to the first exemplary embodiment, the number of cavity portions 37 provided in stator core 31 is a common divisor of the number of teeth 33 and the number of magnetic poles of rotor 2. Accordingly, in a case where the positions of centers of gravity 37w of cavity portions 37 are arranged at equal intervals in the circumferential direction of stator body 32, a positional relationship between cavity portion 37 and tooth 33 can have a similar structure. Accordingly, the unevenness in magnetic flux density in the circumferential direction of stator core 31 can be reduced, and the rotational stability of rotor 2 can be improved.

### (5) Modifications

Hereinafter, modifications of the first exemplary embodiment will be described.

### First Modification

As a first modification of the first exemplary embodiment, center of gravity 37w of cavity portion 37 may not be present on imaginary straight line L2 connecting tooth 33 closest to cavity portion 37 and axis A1. For example, as illustrated in FIG. 6, center of gravity 37w of cavity portion 37 may be present on imaginary straight line L3 connecting position P1 on outer peripheral edge 391 of stator body 32 positioned between two adjacent teeth 33 along circumferential direction D7 and axis A1. Note that, FIG. 6 is a schematic view illustrating a positional relationship between cavity portion 37 of stator core 31 and tooth 33 of the motor according to the first modification. Even in such a case, in a case where distance D3 between cavity portion 37 and outer peripheral edge 391 of stator body 32 is sufficiently large, effects similar to the effects of the first exemplary embodiment can be obtained. That is, the magnetic flux from tooth 33 can easily pass through a region between cavity portion 37 and outer peripheral edge 391 of stator body 32 in stator core 31.

### Second Modification

As a second modification of the first exemplary embodiment, all the plurality of cavity portions 37 provided in stator core 31 may have the same shape. For example, all the plurality of cavity portions 37 may have a cylindrical shape extending in extending direction A2. Alternatively, for example, all the plurality of cavity portions 37 may have a regular hexagonal prism shape extending in extending direction A2.

### Third Modification

As a third modification of the first exemplary embodiment, the number of teeth 33 and the number of magnetic poles of rotor 2 may be any numbers. For example, the number of teeth 33 may be 12, and the number of magnetic poles of rotor 2 may be 8 (8 poles 12 slots). In this case, the number of cavity portions 37 is preferably 2 or 4. Alternatively, for example, the number of teeth 33 may be 10, and the number of magnetic poles of rotor 2 may be 12 (10 poles 12 slots). The number of cavity portions 37 is preferably 2. Note that, in the first exemplary embodiment, since the number of teeth is 18 and the number of magnetic poles of rotor 2 is 16, the number of cavity portions 37 is preferably 2.

### Fourth Modification

As a fourth modification of the first exemplary embodiment, the present modification is not limited to the configuration in which bearing 52 is disposed in shaft hole 36, and bearing 52 may be in a positional relationship in which rotor core 21 is sandwiched between bearing 51 and bearing 52 in extending direction A2 of axis A1. That is, at least bearing 51 is disposed within shaft hole 36 of stator core 31, and bearing 52 holds rotary shaft 20. Accordingly, a similar effect is obtained.

### Fifth Modification

As a fifth modification of the first exemplary embodiment, cavity portion 37 is not limited to a columnar shape or a prism shape extending in extending direction A2, and cavity portion 37 may have a truncated cone shape or a truncated pyramid shape. For example, cavity portion 37 may have a conical shape, a pyramid shape, a truncated cone shape, or a truncated pyramid shape. In cavity portion 37, in extending direction A2 of axis A1, a sectional area of a cross section having extending direction A2 as a normal direction is larger at a position closer to circuit board 4, and a sectional area of a cross section having extending direction A2 as a normal direction is smaller at a position farther from circuit board 4. Even with such a configuration, since electronic component 41 can be disposed in a recess, a similar effect is obtained.

### Sixth Modification

As a sixth modification of the first exemplary embodiment, the present modification is not limited to the configuration in which cavity portion 37 penetrates stator body 32 along extending direction A2 of axis A1, and cavity portion 37 may be a recess extending in extending direction A2. That is, cavity portion 37 may be a depression formed in a surface of stator body 32 facing circuit board 4. Cavity portion 37 is opened on the surface of stator body 32 facing circuit board 4, and has a depth necessary for electronic component 41 to be disposed on the inside. Alternatively, cavity portion 37 may have a shape in which, in extending direction A2 of axis A1, the sectional area of the cross section having extending direction A2 as the normal direction is larger at the position closer to circuit board 4 and the sectional area of the cross section having extending direction A2 as the normal direction is smaller at the position farther from circuit board 4. The shape of cavity portion 37 is, for example, a columnar shape, a prism shape, a conical shape, a pyramid shape, a truncated cone shape, a truncated pyramid shape, a hemispherical shape, or the like. In other words, a part of cavity portions 37 is closed to such an extent that there is no problem in disposing electronic component 41 on the inside. For example, in a case where stator core 31 is a multilayer core including a plurality of steel plates, cavity portion 37 may not be formed in a part of the plurality of steel plates constituting stator core 31. Even with such a configuration, since electronic component 41 can be disposed in a recess, a similar effect is obtained.

### Seventh Modification

As a seventh modification of the first exemplary embodiment, the number of electronic components 41 is not limited to 2. For example, in a case where the number of electronic components 41 is one, electronic component 41 is disposed inside any one of cavity portions 371 to 376. In addition, for example, in a case where the number of electronic components 41 is 3, first electronic component 41 is disposed, for example, within cavity portion 371. In addition, second electronic component 41 is disposed, for example, within cavity portion 372. In addition, third electronic component 41 is disposed within any one cavity portion 37 of cavity portions 373 to 376.

### Eighth Modification

As an eighth modification of the first exemplary embodiment, the present modification is not limited to the configuration in which circuit board 4 has a circular plate shape, and circuit board 4 may have a semicircular shape or a fan shape. Alternatively, circuit board 4 may be a polygon. That is, as long as electronic component 41 can be disposed within cavity portion 37, an area of circuit board 4 may be reduced to the minimum.

### Second Exemplary Embodiment

In a second exemplary embodiment, blower 6 including motor 1 according to the first exemplary embodiment will be described with reference to the drawings.

### (1) Configuration

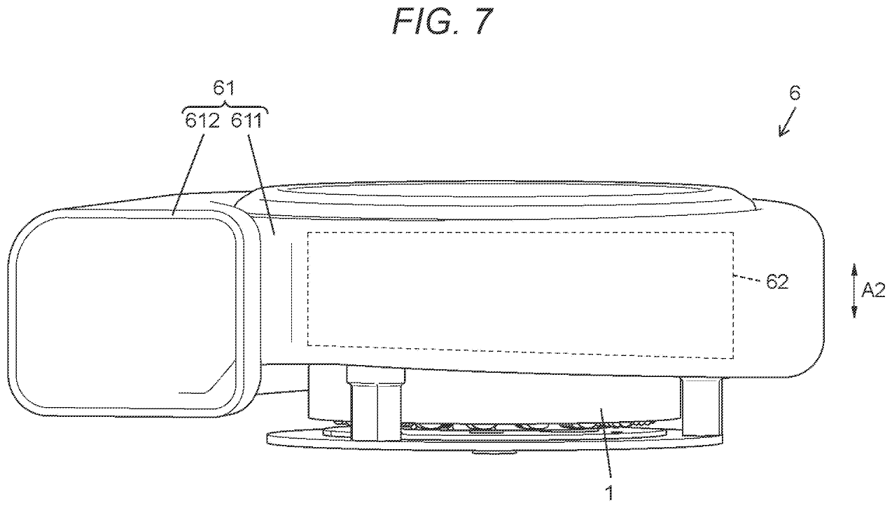

FIG. 7 is a schematic view of blower 6 according to the second exemplary embodiment. As illustrated in FIG. 7, blower 6 according to the second exemplary embodiment includes motor 1, case 61, and blade 62. Motor 1 and blade 62 are stored in case 61. Motor 1 is directly or indirectly coupled to blade 62, and blade 62 rotate in conjunction with rotation of motor 1.

Case 61 includes main body 611 and exhaust flange 612. Main body 611 has a tubular shape and extends in extending direction A2 of axis A1 (see FIG. 1) of motor 1. Exhaust flange 612 has a tubular shape and protrudes in a direction orthogonal to extending direction A2 of axis A1 of motor 1. A space inside main body 611 is communicatively connected to a space inside exhaust flange 612. Main body 611 and exhaust flange 612 of case 61 are integrally formed by using, for example, resin.

Blade 62 is rotated by motor 1. More specifically, blade 62 is stored in case 61 to be directly or indirectly coupled to motor 1. For example, blade 62 is attached to a portion of rotary shaft 20 protruding from motor 1 to an inside of case 61 (upward in FIG. 7). Within case 61, blade 62 rotates in conjunction with rotation of motor 1.

### (2) Effects

According to blower 6 of the second exemplary embodiment, electronic component 41 is disposed inside cavity portion 37 of stator core 31. Accordingly, even though electronic component 41 is a tall component such as an inductor, a transformer, or a capacitor, stator core 31 and circuit board 4 can be brought close to each other along extending direction A2 of axis A1. Accordingly, motor 1 can be thinned in extending direction A2. Accordingly, in a case where a thickness of case 61 in extending direction A2 is the same, blower 6 can be thinner than a blower using a motor of the related art. In addition, in a case where the thickness of blower 6 in extending direction A2 is the same, thicknesses of case 61 and blade 62 in extending direction A2 can be increased by a thickness of motor 1 in extending direction A2. Accordingly, in a case where the thickness of the blower in extending direction A2 is the same as the blower using the motor of the related art, a cooling effect can be increased by increasing an air volume.

### Third Exemplary Embodiment

In a third exemplary embodiment, vehicle (moving body) 7 including blower 6 according to the second exemplary embodiment will be described with reference to the drawings.

### (1) Configuration

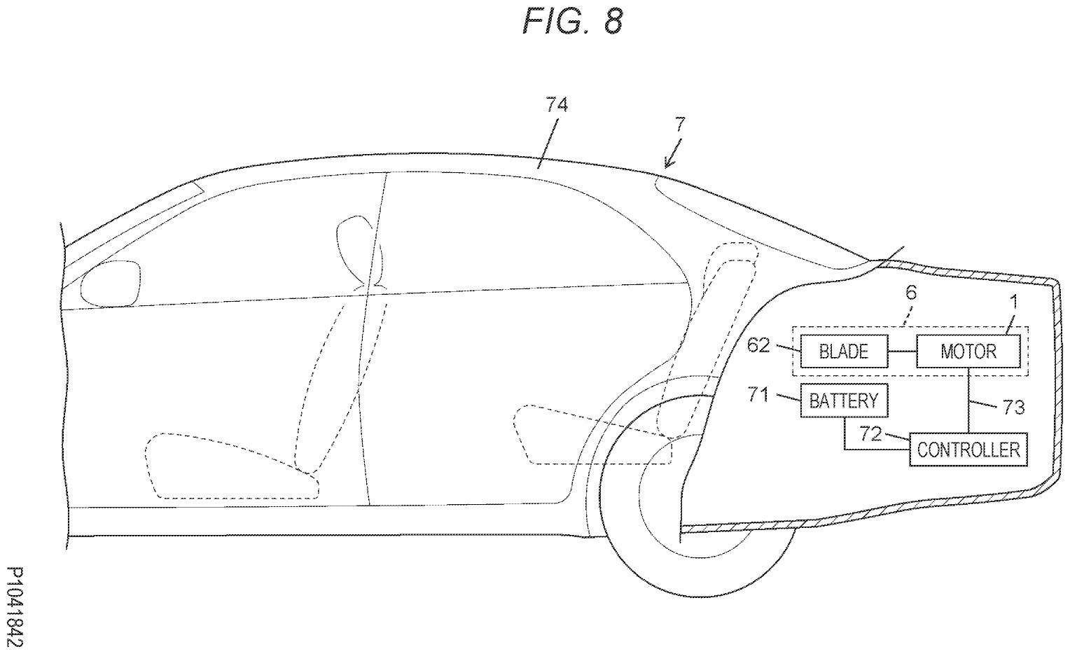

FIG. 8 is a schematic view of vehicle 7 according to the third exemplary embodiment. As illustrated in FIG. 8, vehicle 7 according to the third exemplary embodiment includes blower 6, battery 71, controller 72, cable 73, and vehicle body 74 (moving body main body). Note that, for blower 6 according to the third exemplary embodiment, components similar to blower 6 (see FIG. 7) according to the second exemplary embodiment are denoted by the same reference marks, and the description thereof will be omitted.

In the example illustrated in FIG. 8, vehicle 7 is a four-wheeled hybrid automobile in which an engine and battery 71 for driving are mounted on vehicle body 74. Note that, vehicle 7 is not limited to a hybrid automobile, and may be an electric automobile.

Battery 71 includes, for example, a lithium ion battery, a nickel hydrogen battery, or the like, and supplies power to motor 1, a drive motor for driving vehicle 7, or the like.

Controller 72 is electrically connected to blower 6 by cable 73 to control motor 1 of blower 6. More specifically, controller 72 is electrically connected to circuit board 4 (see FIG. 2) of motor 1 by cable 73. In addition, controller 72 controls battery 71. More specifically, controller 72 controls power supply from battery 71 to motor 1, the drive motor, and the like.

Blower 6, battery 71, controller 72, and cable 73 are mounted on vehicle body 74.

Blower 6 used in vehicle 7 functions as a cooling fan system to suppress a temperature rise of battery 71. In blower 6, due to rotational driving of motor 1, blade 62 rotates to send air to battery 71. Accordingly, battery 71 is air-cooled, and the temperature rise of battery 71 is suppressed.

### (2) Effects

In vehicle 7 according to the third exemplary embodiment, electronic component 41 is disposed inside cavity portion 37 of stator core 31. Accordingly, even though electronic component 41 is a tall component such as an inductor, a transformer, or a capacitor, stator core 31 and circuit board 4 can be brought close to each other along extending direction A2 of axis A1. Accordingly, motor 1 can be thinned in extending direction A2. Accordingly, the thickness of blower 6 in the extending direction A2 can be reduced. Alternatively, since the thickness of motor 1 is small in extending direction A2, case 61 and blade 62 of blower 6 can be extended in extending direction A2 without changing the size of blower 6. Accordingly, a cooling effect by blower 6 can be easily improved.

The exemplary embodiments and modifications described above are merely part of various exemplary embodiments and modifications of the present disclosure. In addition, the exemplary embodiments and the modifications can be variously modified depending on a design and the like as long as an object of the present disclosure can be achieved.

### Aspects

Motor (1) according to a first aspect is outer rotor motor (1). Motor (1) includes stator (3), rotor (2), and electronic component (41). Stator (3) includes stator core (31). Rotor (2) includes rotary shaft (20), and has axis (A1) of rotary shaft (20) as a rotation center. Stator core (31) includes stator body (32) and a plurality of teeth (33). Stator body (32) includes shaft hole (36) into which rotary shaft (20) is inserted. The plurality of teeth (33) are provided at end portion (39) of stator body (32). Stator body (32) further includes cavity portion (37) different from shaft hole (36). Electronic component (41) is disposed in cavity portion (37).

According to motor (1) of the above aspect, tall electronic component (41) is disposed within cavity portion (37) formed in stator core (31), and thus, a thickness of motor (1) along extending direction (A2) of axis (A1) can be reduced without influencing rotary shaft (20) of rotor (2).

In the first aspect, in motor (1) according to a second aspect, cavity portion (37) is a circle in plan view from extending direction (A2) of axis (A1).

According to motor (1) of the above aspect, since electronic component (41) may be present inside cavity portion (37) in plan view in extending direction (A2) of axis (A1), restrictions on a shape and a position of electronic component (41) are small. Accordingly, for example, it is easy to design circuit board (4) on which electronic component (41) is mounted. In addition, in stator (3), variations in magnetic flux density due to cavity portion (37) can be reduced.

In the first aspect, in motor (1) according to a third aspect, cavity portion (37) has a polygon in plan view from extending direction (A2) of axis (A1).

According to motor (1) of the above aspect, since electronic component (41) may be present inside cavity portion (37) in plan view in extending direction (A2) of axis (A1), restrictions on a shape and a position of electronic component (41) are small. Accordingly, for example, it is easy to design circuit board (4) on which electronic component (41) is mounted. In addition, in stator (3), variations in magnetic flux density due to cavity portion (37) can be reduced.

In the third aspect, in motor (1) according to a fourth aspect, cavity portion (37) is a quadrangle in plan view from extending direction (A2) of axis (A1).

According to motor (1) of the above aspect, since a sectional shape of electronic component (41) is a quadrangle, an increase in a sectional area of cavity portion (37) can be reduced. In addition, it is easy to provide cavity portion (37) in stator core (31).

In any one of the first to fourth aspects, in motor (1) according to a fifth aspect, cavity portion (37) is present on imaginary straight line (L1) orthogonal to extending direction (A2) of axis (A1) and passing through one of the plurality of teeth (33) and axis (A1).

According to motor (1) of the above aspect, it is easy to increase distance (D3) between tooth (33) and outer peripheral edge (391) of stator body (32). Accordingly, magnetic flux from tooth (33) can easily pass through a region between cavity portion (37) and outer peripheral edge (391). In addition, strength of a portion between outer peripheral edge (391) of stator body (32) and cavity portion (37) can be further increased.

In any one of the first to fifth aspects, in motor (1) according to a sixth aspect, a plurality of cavity portions (37) are provided in stator body (32). Electronic component (41) is disposed inside one cavity portion (37) of the plurality of cavity portions (37).

In motor (1) according to the above aspect, electronic component (41) may be disposed inside any one of the plurality of cavity portions (37). Accordingly, for example, stator core (31) can be shared by a plurality of types of motors having the same structure of stator (3) and different layouts of circuit board (4) on which electronic component (41) is mounted.

In the sixth aspect, in motor (1) according to a seventh aspect, stator body (32) has a line-symmetrical shape with respect to imaginary straight line (L1) orthogonal to axis (A1) in a plan view from extending direction (A2) of axis (A1).

According to motor (1) of the above aspect, it is possible to reduce deviation of a magnetic flux density in circumferential direction (D7) of stator (3).

In the sixth or seventh aspect, in motor (1) according to an eighth aspect, the total number of the plurality of cavity portions (37) is a divisor of the total number of the plurality of teeth (33).

In motor (1) according to the above aspect, in a case where the plurality of cavity portions (37) having the same shape are disposed such that centers of gravity (37w) thereof are arranged at equal intervals along circumferential direction (D7) of stator (3), a relative positional relationship between cavity portion (37) and tooth (33) closest to cavity portion (37) can be the same in circumferential direction (D7) of stator (3). Accordingly, it is possible to reduce the deviation of the magnetic flux density in circumferential direction (D7) of stator (3).

In the eighth aspect, in motor (1) according to a ninth aspect, the total number of the plurality of cavity portions (37) is a divisor of the total number of magnetic poles of rotor (2).

In motor (1) according to the above aspect, in a case where the plurality of cavity portions (37) having the same shape are disposed such that centers of gravity (37w) of the cavity portions are arranged at equal intervals along circumferential direction (D7) of stator (3), a relative positional relationship between the magnetic poles of rotor (2) and cavity portion (37) can be the same in rotation direction (D7) of rotor (2). Accordingly, variations in torque of rotor (2) can be reduced, and rotational characteristics can be stabilized.

In any one of the sixth to ninth aspects, motor (1) according to a tenth aspect further includes a plurality of electronic components (41). The plurality of cavity portions (37) include first cavity portion (37) and second cavity portion (37). The plurality of electronic components (41) include first electronic component (41) and second electronic component (41). First electronic component (41) is disposed within first cavity portion (37). Second electronic component (41) is disposed within second cavity portion (37).

According to motor (1) of the above aspect, since the plurality of electronic components (41) are disposed in different cavity portions (37), a sectional area of each cavity portion (37) can be reduced. Accordingly, cavity portion (37) can be easily provided in stator core (31).

In the tenth aspect, in motor (1) according to an eleventh aspect, stator body (32) has a hollow cylindrical shape with axis (A1) as a central axis. First cavity portion (37) and second cavity portion (37) has distance (D6) of less than or equal to 50% of diameter (D4) of end portion (39) of stator body (32).

According to motor (1) of the above aspect, in a case where the number of electronic components (41) is small, electronic components (41) are disposed close to each other, and thus, a wiring distance between first electronic component (41) and second electronic component (41) can be shortened. Circuit board (4) on which first electronic component (41) and second electronic component (41) are provided can be downsized.

In any one of the first to eleventh aspects, in motor (1) according to a twelfth aspect, shaft hole (36) has a cylindrical shape with axis (A1) as a central axis. Cavity portion (37) and shaft hole (36) has shortest distance (D2) of 5% or more of diameter (D1) of shaft hole (36).

According to motor (1) of the above aspect, strength of stator core (31) between shaft hole (36) and cavity portion (37) is sufficiently increased. Accordingly, rigidity of stator core (31) can be sufficiently ensured.

In any one of the first to twelfth aspects, in motor (1) according to a thirteenth aspect, cavity portion (37) and outer peripheral edge (391) of stator body (32) has shortest distance (D3) of 50% or more of width (W1) of tooth (33) in a direction orthogonal to a protruding direction of tooth (33).

In motor (1) according to the above aspect, magnetic flux from tooth (33) easily passes through a region between outer peripheral edge (391) of stator body (32) and cavity portion (37). Accordingly, variations in magnetic flux density among the plurality of teeth (33) can be reduced, and the rotation of rotor (2) can be stabilized. In addition, strength of the region between outer peripheral edge (391) of stator body (32) and cavity portion (37) is sufficiently increased. Accordingly, rigidity of stator core (31) can be sufficiently ensured.

In any one of the first to thirteenth aspects, motor (1) according to a fourteenth aspect further includes bearing (51). Bearing (51) is disposed within shaft hole (36) to hold rotary shaft (20) of rotor (2).

According to motor (1) of the above aspect, bearing (51) is disposed in shaft hole (36), and thus, rotational stability of rotor (2) can be improved, and a lifespan of motor (1) can be extended. In addition, even though electronic component (41) is a tall component, since disposition of bearing (51) is not influenced, even though motor (1) is thinned, the lifespan of motor (1) is hardly influenced.

Blower (6) according to a fifteenth aspect includes motor (1) according to any one of the first to fourteenth aspects and blade (62). Blade (62) is fixed to rotary shaft (20) of motor (1).

According to blower (6) of the above aspect, since motor (1) can be thinned in extending direction (A2) of axis (A1), blower (6) can be thinned.

Vehicle (7) according to a sixteenth aspect includes blower (6) according to the fifteenth aspect and vehicle body (74) that stores blower (6).

According to vehicle (7) of the above aspect, since motor (1) can be thinned in extending direction (A2) of axis (A1), blower (6) can be thinned.

### INDUSTRIAL APPLICABILITY

According to the motor, the blower, and the vehicle according to the present disclosure, the motor can be further thinned, and thus, the blower can be thinned. The blower can be easily disposed in the vehicle. That is, the motor, the blower, and the vehicle according to the present disclosure are industrially useful.

### REFERENCE MARKS IN THE DRAWINGS

1 motor
2 rotor
20 rotary shaft
21 rotor core
3 stator
31 stator core
32 stator body
33 tooth
36 shaft hole
37, 371, 372, 373, 374, 375, 376 cavity portion
39 end portion
391 outer peripheral edge
41, 411, 412 electronic component
51, 52 bearing
6 blower
62 blade
7 vehicle
74 vehicle body
A1 axis
A2 extending direction
D1, D4 diameter
D2, D3, D6 distance
W1 width
L1, L2, L3 imaginary straight line

1. A motor that is an outer rotor motor, the motor comprising:
a stator including a stator core;
a rotor including a rotary shaft and having an axis of the rotary shaft as a rotation center; and
an electronic component,
wherein
the stator core includes
a stator body including a shaft hole into which the rotary shaft is inserted, and
a plurality of teeth provided in an end portion of the stator body,
the stator body further includes a cavity portion different from the shaft hole, and
the electronic component is disposed within the cavity portion.

2. The motor according to claim 1, wherein the cavity portion is a circle in plan view from an extending direction of the axis.

3. The motor according to claim 1, wherein the cavity portion is a polygon in plan view from an extending direction of the axis.

4. The motor according to claim 3, wherein the cavity portion is a quadrangle in plan view from the extending direction of the axis.

5. The motor according to claim 1, wherein the cavity portion is present on an imaginary straight line orthogonal to an extending direction of the axis and passing through one of the plurality of teeth and the axis.

6. The motor according to claim 1, wherein
the stator body is provided with a plurality of cavity portions each being the cavity portion, and
the electronic component is disposed inside one cavity portion of the plurality of cavity portions.

7. The motor according to claim 6, wherein the stator body has a line-symmetrical shape with respect to an imaginary straight line orthogonal to the axis in plan view from an extending direction of the axis.

8. The motor according to claim 6, wherein a total number of the plurality of cavity portions is a divisor of the number of the plurality of teeth.

9. The motor according to claim 8, wherein the total number of the plurality of cavity portions is a divisor of a total of magnetic poles of the rotor.

10. The motor according to claim 6, further comprising a plurality of electronic components each being the electronic component,
wherein
the plurality of cavity portions include a first cavity portion and a second cavity portion,
the plurality of electronic components include a first electronic component and a second electronic component,
the first electronic component is disposed within the first cavity portion, and
the second electronic component is disposed within the second cavity portion.

11. The motor according to claim 10, wherein
the stator body has a hollow cylindrical shape with the axis as a central axis, and
the first cavity portion and the second cavity portion has a distance of less than or equal to 50% of a diameter of the end portion of the stator body.

12. The motor according to claim 1, wherein
the shaft hole has a cylindrical shape with the axis as a central axis, and
the cavity portion and the shaft hole has a shortest distance of 5% or more of a diameter of the shaft hole.

13. The motor according to claim 1, wherein
the cavity portion and an outer peripheral edge of the stator body has a shortest distance of 50% or more of a width of a tooth in a direction orthogonal to a protruding direction of the tooth.

14. The motor according to claim 1, further comprising a bearing member,
wherein the bearing member is disposed within the shaft hole to hold the rotary shaft of the rotor.

15. A blower comprising:
the motor according to claim 1; and
a blade fixed to the rotary shaft of the motor.

16. A vehicle comprising:
the blower according to claim 15; and
a vehicle body that stores the blower.
